(19) United States
(12) Patent Application Publication
(10) Pub. No.: US 2005/0138651 A1
(43) Pub. Date: Jun. 23, 2005

(54) Slot-in optical recording and/or reproduction apparatus

(75) Inventors: Chung-Ta Liao, Hsinchu City (TW); Jui-Chiang Lin, Hsinchu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/012,201

(22) Filed: Dec. 16, 2004

(30) Foreign Application Priority Data
Dec. 17, 2003 (TW) 92222123

(51) Int. Cl. G11B 17/04; G11B 7/08; G11B 7/085; G11B 7/09

(52) U.S. Cl. 720/619; 720/624

(57) ABSTRACT

A slot-in optical recording and/or reproducing apparatus (optical read/write device), which reads/writes data from/to an optical storage media (e.g., compact disk), can smoothly lead an optical storage media is disclosed herein, the slot-in optical read/write device at least includes the elements described below. A slot formed at the panel of the front portion of the case, thus enable the optical disk to enter/leave the slot-in optical recording and/or reproducing apparatus through the slot. A roller positioned in the case adjacent to the slot to provide a force which delivers the optical disk into/out of the case. A guiding mechanism positioned between the slot and the roller. The guiding mechanism is used to confine the optical disk, and make the optical storage media smoothly reach the top portion of the roller.

### BACKGROUND OF THE INVENTION

(1) Field of the Invention

The invention relates to a slot-in optical recording and/or reproducing apparatus, and more particularly to the guiding device in the slot-in optical recording and/or reproducing apparatus such as an optical slot-in compact disk drive.

(2) Description of the Prior Art

As various applications in multi-media technology widely spread, the demand for the large-volume data storage media, such as Compact Disk, and the access device, such as Compact Disk Drive, have been growing rapidly. In particular, the application using CD as a storage media has remarkable increased, so the optical recording and/or reproducing apparatus (named as optical read/write device hereafter), which is used to read/write the CD, is also extremely popular. Nowadays, for example, each Personal Computer at least has one optical access (read/write) device, such as CD-ROM, CD-RW, Slot-In Optical read/write device, Combo CD drive, DVD-R/RW drive, . . . and external CD drive.

In order to easily and quickly draw/insert the CD from/to the CD drive, as well as to the request for slim, thin, and light product design, the slot-in is a very attractive option for the CD drive design. So this type of design (slot-in type) is generally adopted in car stereo system and notebook computer as an optical read/write device to read and/or write CD.

FIG. 1 schematically shows a perspective view of the front portion of the traditional slot-in optical read/write drive 2 and a Compact Disk 4 fed thereto. Sparing the ejectable tray for loading CD, the slot-in optical drive 2 prevails other types of the optical driver. When the user wants to insert a CD to the slot-in optical drive 2, the user only has to push the CD 4 into the slot-in optical drive 2 through slot 6.

In addition, FIG. 2 schematically illustrates the cross-section of the front portion of the traditional slot-in optical drive in side view. Once the CD 4 contacts the roller 8, the rolling of roller 8 draws the CD 4 to move inwardly/outwardly, and thus the traditional slot-in optical read/write drive 2 can draw/eject the CD 4 correspondingly.

However, sometimes the user do not feed the CD 4 into the slot-in optical drive 2 in an inappropriate manner, such as push the CD 4 into the slot 6 with a wrong angle (far from being perpendicular to the front panel of the case of the slot-in optical drive 2). As shown in FIG. 3, the CD 4 is inserted into the slot-in optical drive 2 through the slot 6 in an inappropriate angle toward the roller 8. In this case, the CD 4 will be pushed toward against roller 8, it may not only hinder the user from normal operation, but also may make the parts or component of the slot-in optical drive 2 out of order, malfunction, or even broken.

So it is definitely welcome to the skilled in the art to introduce a guiding mechanism to the slot-in optical drive 2 to solve the problems mentioned above.

### SUMMARY OF THE INVENTION

Accordingly, it is one object of the present invention to provide a guiding mechanism to lead the compact disk along the surface of the guiding mechanism to slide to the top portion of the roller within the optical read/write drive, thus enabling the user to smoothly insert the compact disk (or optical storage media, e.g., optical disk) through the slot to the optical read/write drive.

The present invention relates to a slot-in type optical drive which can smoothly lead optical disk into the drive includes a case having a slot, a roller, a base plate, and a guiding mechanism.

According to the preferred embodiment of the present invention, the case has a slot formed at a panel of the front portion of the case, thus enable the optical disk to enter/leave the slot-in optical drive through the slot. The slot mentioned above is made possible the optical storage media (compact disk) move inwardly/outwardly to enter/leave the optical disk drive. The roller is positioned in the case and is adjacent to the slot, thus providing a force delivering the optical disk into/out of the case. The rotation of the roller can move the optical disk inwardly/outwardly when the disk contact the roller.

The base plate is positioned over the roller, the base plate is positioned to parallel to the optical disk passing below, the base plate includes a guiding structure, wherein the guiding structure is formed by upwardly inclined stretching from an edge of the base plate to an upper position higher than the slot.

The guiding mechanism mentioned above is positioned between the slot and the roller. The guiding mechanism is used to confine the optical disk, and make the optical disk reach the top portion of the roller. The guiding mechanism includes a first guiding part and a second guiding part, the first guiding part is formed closed to the roller and is horizontal posed. The second guiding part is downwardly inclined stretching from the first guiding part to a lower position lower than the slot. The second guiding part is used to guide the front edge of the optical disk to move along the surface of the first guiding part to reach the top portion of the roller.

For the reason mentioned above, the user can smoothly insert the optical disk into the optical read/write drive with the guiding mechanism according to the present invention. Thus, when the user insert the optical storage media into the optical read/write drive, the possibility to push the optical storage media against the roller of the driver is largely reduced, and the probability of malfunction is obviously reduced. So the quality of the optical read/write drive with the guiding mechanism according to the present invention is apparently improved.

The present invention will now be specified with reference to its preferred embodiment illustrated in the drawings.

### BRIEF DESCRIPTION OF THE DRAWINGS

FIG. 1 schematically shows a perspective view of the front portion of the traditional slot-in optical read/write drive 2 and a Compact Disk 4 fed thereto;

FIG. 2 schematically illustrates the cross-section of the front portion of the traditional slot-in optical drive in side view;

FIG. 3 illustrates how the compact disk is inserted into the slot-in optical drive through the slot in an inappropriate angle toward the roller;

FIG. 4 schematically illustrates the guide mechanism accompanied with the front portion of the optical read/write drive in a cross-sectional side view according to the first embodiment of the present invention;

FIG. 5 schematically illustrates the bottom plate and the read/write operating module positioned thereupon according to the present invention;

FIG. 6 schematically illustrates the relation between the guiding mechanism and the read/write operating module according to the second embodiment of the present invention;

FIG. 7 schematically illustrates the bottom plate and the guiding mechanism fixed thereupon according to the third embodiment of the present invention;

FIG. 8 schematically illustrates the fourth embodiment of the present invention in a cross sectional view, in which the base plate includes two supporting parts respectively fixed at the right and the left end of the base plate's front edge closing to the slot; and

FIG. 9 schematically illustrates the base plate according to the fourth embodiment of the present invention in a front view, showing that the compact disk can freely move through the space limited between the two supporting parts.

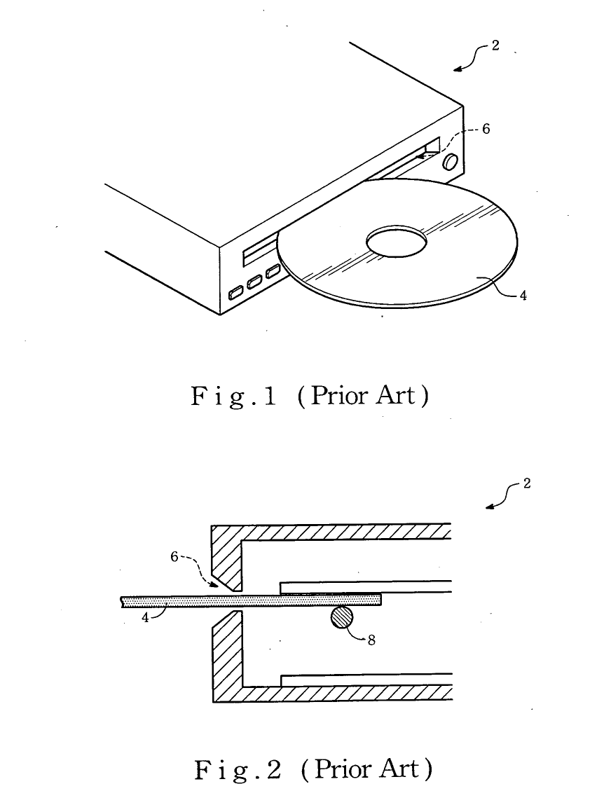

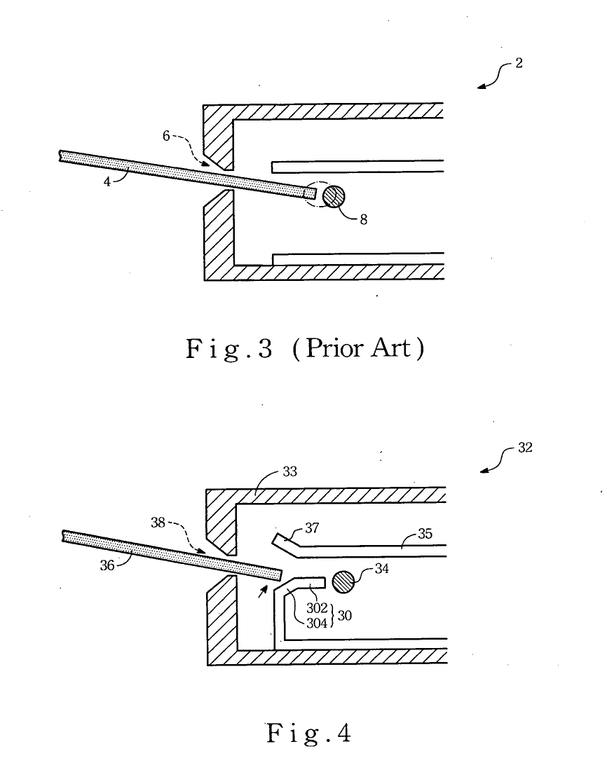

### DESCRIPTION OF THE PREFERRED EMBODIMENT

Please refer to FIG. 4, which schematically illustrates the guide mechanism in a cross-sectional side view according to the first embodiment of the present invention. The present invention is related to a guiding mechanism, which can often be utilized in a slot-in optical recording and/or reproducing apparatus, such as slot-in optical read/write drive, which is the preferred embodiment in this disclosure. However the name of the apparatus using the present invention does not confine the scope of the present invention.

As shown in FIG. 4, the slot-in optical driver 32 includes the guiding mechanism 30, the roller 34, base plate 35, and a case 33 with a slot 38 formed thereupon, through which the CD 36 can enter the slot-in optical driver 32. It is noted that the CD 36 is not limited to compact disk, every kind of optical disk, such DVD, can be used as the CD 36.

The slot 38 is formed at the front of the case of the slot-in optical driver 32, and the roller 34 outwardly/inwardly rotates to eject/drag the CD 36 out of/into the slot-in optical driver 32.

In the preferred embodiment of the present invention, the base plate 35 and the roller 34 are fixed at a first position and a second position (e.g., over and under) respectively. The CD 36 passes into/out of the slot-in optical driver 32 through the space between the base plate 35 and the roller 34. The base plate 35 includes a base guiding protrusion 37, which, in the preferred embodiment of the present invention, is formed by upwardly inclined stretching from the side of the base plate 35 close to the slot 38, as shown in FIG. 4. So it is obvious that the CD dragged by the slot-in optical driver 32 will firstly be guided to pass the base guiding protrusion 37 and the guiding mechanism 30 therebetween, then the CD 36 will be pushed to contact the top portion of the roller 34. Subsequently, the CD 36 will be dragged by contacting to the rotating roller 34. Finally, the CD 36 reached a predetermined position where the slot-in optical driver 32 can record/reproduce the date on the CD 36.

The guiding mechanism 30 is positioned and/or fixed between the slot 38 and the roller 34. In the preferred embodiment of the present invention, the guiding mechanism 30 includes a first guiding part 302 and a second guiding part 304. The first guiding part 302 is close to the roller 34 and is horizontally posed. The horizontal level of the top surface of the first guiding part 302 is lower than that of the roller 34. The second guiding part 304 is fixed and is formed on the position closer to the slot 38 with respect to the first guiding part 302. The second guiding part 304 is formed downwardly inclined stretching from the first guiding part 302.

As illustrated in FIG. 4, it is obvious that, even if the CD 34 has not been fed into the slot-in optical driver 32 with an appropriate angle, the upper surface of the second guiding part 304, which is downwardly inclined stretching from the first guiding part 302, will force the front edge of the CD 36 to move in the direction to the upper surface of the first guiding part 302. Thus the CD 36 can finally touch the top portion of the roller 34, and the rotating of the roller 34 can drag the CD 36 in a predetermined direction. The CD 36 reached a predetermined position where the slot-in optical driver 32 can record/reproduce the data on the CD 36.

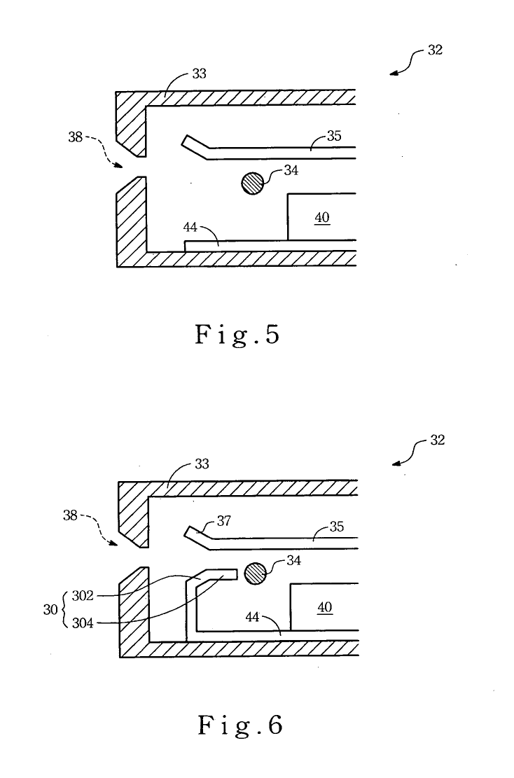

FIG. 5 schematically illustrates the bottom plate and the read/write operating module positioned thereupon. The slot-in optical driver 32 further includes a bottom plate 44 which adopting the read/write operating module 40. In the preferred embodiment of the present invention, the bottom plate 44 and the read/write operating module 40 are both formed under the roller 34, e.g., at the bottom of the case of the slot-in optical driver 32.

Referring to FIG. 6, the special relation between the guiding mechanism and the read/write operating module according to the second embodiment of the present invention is shown. The guiding mechanism 30 includes the first guiding part 302, the second guiding part 304. In the second embodiment of the present invention illustrated in FIG. 6, the guiding mechanism 30 is formed by stretching from the bottom plate 44, i.e., the guiding mechanism 30 and the bottom plate 44 are manufactured in one piece.

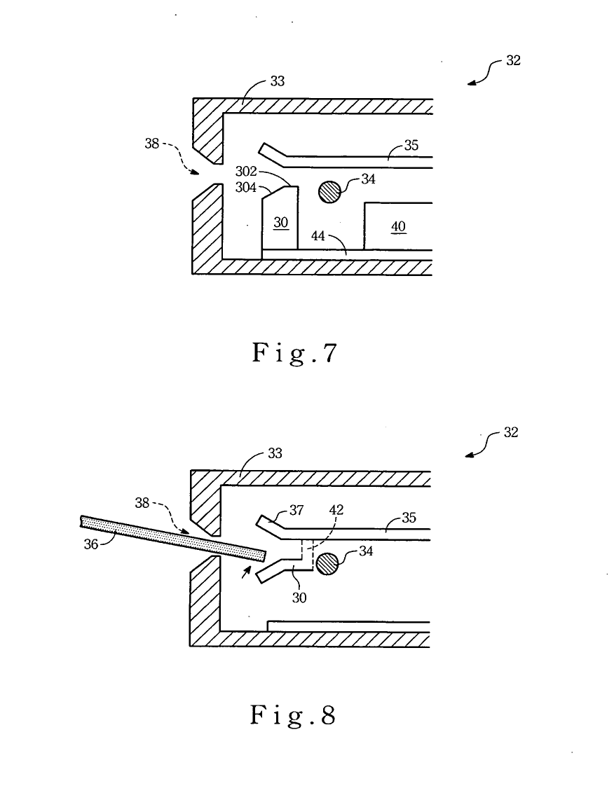

Referring to FIG. 7, the bottom plate and the guiding mechanism fixed thereupon according to the third embodiment of the present invention is shown. The guiding mechanism 30 includes the first guiding part 302, the second guiding part 304. The bottom plate 44 and the guiding mechanism 30 are not manufactured in one piece. Besides, the guiding mechanism 30 is screwed or stuck on the bottom plate 44. It does not limit the way to dispose the guiding mechanism 30 on the bottom plate 44. The bottom plate 44 and the guiding mechanism 30 can be formed either of metallic or plastic material.

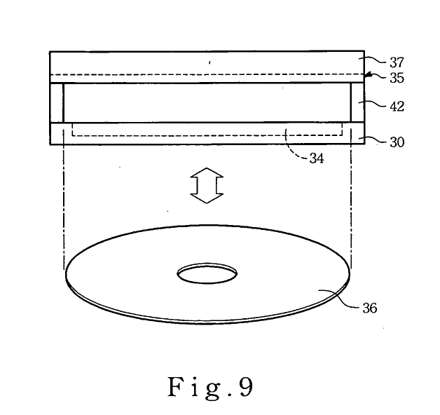

Refer to FIG. 8, which illustrates the fourth embodiment of the present invention, in which the slot-in optical driver 32 includes the roller 34, the base plate 35 and the case 33 with the slot 38 formed thereupon. In this embodiment of the present invention, the base plate 35 includes two supporting parts 42 respectively fixed at the right and the left edge of the base plate 35 closing to the slot 38. The two downwardly stretched supporting parts 42 are connected to the guiding mechanism 30. Refer to FIG. 9, the base plate according to the fourth embodiment of the present invention in a front view is shown. The distance between the inner edge of the two supporting parts 42 is larger than the diameter of the CD 36, so that the two supporting parts 42 does not hinder the CD 36 from passing through the space defined by the base plate 35, the two supporting parts 42 and the guiding mechanism 30 attached thereto. In addition, the guiding mechanism 30 connected to the two supporting parts 42 (all are also manufactured in one piece) restrain the CD 36 to enter the slot-in optical driver 32 within the space confined by the base plate 35 and the guiding mechanism 30. In further aspect of the present invention, the guiding mechanism 30, the two supporting parts 42 and the base plate 35 are manufactured in one piece.

Consequently, with the guiding mechanism 30 according to the preferred embodiments of the present invention, even if the user pushed the CD 36 into the slot 38 with a large angle with respect to the direction perpendicular to the surface of the front panel of the slot-in optical driver 32, the guiding mechanism 30 will direct the CD 36 to smoothly move in the predetermined direction, thus enabling the slot-in optical driver 32 to read/write the date on the CD 36. In other words, even when the storage media is pushed into the slot-in optical recording and/or reproducing apparatus with large angle, the guiding mechanism 30 can direct the media to an appropriate path into the slot-in optical recording and/or reproducing apparatus without its component being out of order, malfunction, or even broken. So the user will feel much smoother when he inserted the media into the slot-in optical recording and/or reproducing apparatus with the guiding mechanism according to the present invention installed inside, thus the quality of the quality of the slot-in optical recording and/or reproducing apparatus has been improved.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. An optical read/write apparatus for reading/writing data from/to an optical storage media, said optical read/write apparatus comprising:
a case having a slot formed at the front of said case, said optical storage media entering/leaving said optical read/write apparatus through said slot;
a roller positioned in said case adjacent to said slot to provide force delivering said optical storage media into/out of said case; and
a guiding mechanism positioned between said slot and said roller for confining said optical storage media to reach top portion of said roller,
wherein said guiding mechanism comprises a first guiding part and a second guiding part, said first guiding part closing to said roller and being horizontal posed, said second guiding part downwardly inclined stretching from said first guiding part to a lower position lower than said slot, said second guiding part guiding the front edge of said optical storage media to move along the surface of said first guiding part to reach said top portion of said roller.

2. The optical read/write apparatus as claimed in claim 1 further comprising a bottom plate positioned under said roller within said case.

3. The optical read/write apparatus as claimed in claim 2, wherein said guiding mechanism is formed integrally by stretching said bottom plate.

4. The optical read/write apparatus as claimed in claim 2, wherein said guiding mechanism is formed of plastic, and is connected to said bottom plate.

5. The optical read/write apparatus as claimed in claim 1 further comprising a base plate positioned above said roller, wherein said base plate comprises a guiding structure, said guiding structure being formed by upwardly inclined stretching from an edge of said base plate to an upper position higher than said slot.

6. The optical read/write apparatus as claim 5, wherein said base plate comprises two supporting parts formed by downwardly stretching from two ends of said edge of said base plate, said guiding mechanism being connected to said two supporting parts, and the diameter of said optical storage media being smaller than the distance between said two supporting parts.

7. The optical read/write apparatus as claimed in claim 1 being a slot-in type optical disk drive.

8. An optical read/write apparatus for reading/writing data from/to an optical storage media, said optical read/write apparatus comprising:
a case having a slot formed at the front of said case, said optical storage media entering/leaving said optical read/write apparatus through said slot;
a roller positioned in said case adjacent to said slot to provide force delivering said optical storage media into/out of said case;
a base plate positioned over said roller, said base plate being positioned to parallel to said optical storage media passing below, said base plate comprising a guiding structure, wherein said guiding structure is formed by upwardly inclined stretching from an edge of said base plate to an upper position higher than said slot; and
a guiding mechanism for providing space which confines said optical storage media to proceed within said space to reach top portion of said roller, said guiding mechanism being positioned between said slot and said roller,
wherein said guiding mechanism comprises a first guiding part and a second guiding part, said first guiding part being formed closing to said roller and being horizontal posed, said second guiding part downwardly inclined stretching from said first guiding part to a lower position lower than said slot, said second guiding part guiding the front edge of said optical storage media to move along surface of said first guiding part to reach said top portion of said roller.

9. The optical read/write apparatus as claimed in claim 8 further comprising a bottom plate, said bottom plate being positioned under said roller within said case.

10. The optical read/write apparatus as claimed in claim 9, wherein said guiding mechanism is formed integrally by stretching said bottom plate.

11. The optical read/write apparatus as claimed in claim 9, wherein said guiding mechanism is formed of plastic, and is connected to said bottom plate.

12. The optical read/write apparatus as claimed in claim 8, wherein said base plate comprises two supporting parts formed by downwardly stretching from two ends of said edge of said base plate, said guiding mechanism being connected to said two supporting parts, and the diameter of said optical storage media being smaller than the distance between said two supporting parts.

13. The optical read/write apparatus as claim 8 being a slot-in type optical disk drive.

14. A guiding mechanism, said guiding mechanism being adopted in an optical read/write apparatus for reading/writing data from/to an optical storage media, said optical read/write apparatus comprising a roller and a case having a slot formed at the front of said case, said optical storage media entering/leaving said optical read/write apparatus through said slot, said optical storage media being pushed inwardly/outwardly by a force into/out of said case corresponding to rotating direction of said roller, wherein said roller is positioned in said case adjacent to sad slot, said guiding mechanism being positioned between said slot and said roller, said guiding mechanism comprising:
a first guiding part positioned horizontally close to said roller, wherein position of said first guiding part leads object on surface to slide to top portion of said roller; and
a second guiding part positioned close to said slot, said second guiding part downwardly inclined stretching from said first guiding part to a lower position lower than said slot, said second guiding part guiding front edge of said optical storage media to move along surface of said first guiding part to reach said top portion of said roller.

15. The guiding mechanism as claimed in claim 14, wherein said optical read/write apparatus further comprises a bottom plate, said bottom plate being positioned under said roller within said case.

16. The guiding mechanism as claimed in claim 15, wherein said guiding mechanism is formed integrally by stretching said bottom plate.

17. The guiding mechanism as claimed in claim 15, wherein said guiding mechanism is formed of plastic, and is connected to said bottom plate.

18. The guiding mechanism as claim 14, wherein said optical read/write apparatus further comprises a base plate positioned over said roller, said base plate being positioned parallel to said optical storage media passing below, said base plate comprising a guiding structure, wherein said guiding structure is formed by upwardly inclined stretching from an edge of said base plate to an upper position higher than said slot.

19. The guiding mechanism as claim 18, wherein said base plate comprises two supporting parts formed by downwardly stretching from two ends of said edge of said base plate, said guiding mechanism being connected to said two supporting parts, diameter of said optical storage media being smaller than distance between said two supporting parts.

20. The guiding mechanism as claim 14, wherein said optical read/write apparatus is a slot-in type optical disk drive.
